(19) United States
(12) Patent Application Publication
(10) Pub. No.: US 2007/0057027 A1
(43) Pub. Date: Mar. 15, 2007

(54) Method and device for filling zones situated in hollows or between tracks with a viscous product on a printed circuit board and apparatus using such a device

(76) Inventors: Francis Bourrieres, Montauban (FR); Clement Kaiser, Montauban (FR); Antonio Cicero, Castronno (IT); Osvaldo Novello, Castronno (IT)

Correspondence Address: JEROME D. JACKSON (JACKSON PATENT LAW OFFICE), 211 N. UNION STREET, SUITE 100, ALEXANDRIA, VA, 22314, US

(21) Appl. No.: 10/566,097

(22) PCT Filed: Jul. 29, 2004
(86) PCT No.: PCT/FR04/02043

§ 371 Date: Jun. 28, 2006

(30) Foreign Application Priority Data
Jul. 30, 2003 (FR) 03/09351
Apr. 2, 2004 (FR) 04/03455

(51) Int. Cl. B23K 31/00; B23K 1/20

(52) U.S. Cl. 228/248.1; 228/214

(57) ABSTRACT

The invention relates to a method and device for filling areas located in hollows (4) which do not open out onto the surface of a substrate (1) without a mask or silk screen. According to the invention, said method consists in associating the following objects according to the order of the direction of relative displacement of a head (12) of a filling product (2) in relation to the substrate (1) i.e. a spreading element (10) for the product to be filled (2) on the surface of the substrate (1); an element for displacing (3) the filling product (2) in the area to be filled (4); an element (7) for adjusting the thickness or raking off the excess filling product (2) such that the above-mentioned filling product (2) remains constantly in contact with the area to be filled (4) from the beginning of the filling operation until raking off of the excess product.

### FIELD OF APPLICATION

The present invention relates to a device for filling zones situated in hollows with respect to a surface, with a more or less viscous liquid product, by extraction of the air or of the gas present in the zones in hollows and by replacement with a filling product. Generally these zones are of long length, narrow, and deep. By way of example, the invention finds its application in the realization of power printed circuits such as those used in the automobile sector. In fact, there exist applications for which substrates having conductive tracks, of copper for example, and having a thickness greater than 100 microns (typically on the order of 400 microns) are used. In these applications, it is necessary to fill the inter-track zones with a dielectric product, this filling having to be without bubbles in order to obtain the optimal electrical characteristics and overthickness strictly at the point of the zones in hollows. Furthermore, the inter-track zones are not necessarily closed. After this filling operation, the printed circuits undergo a cycle of polymerization, followed by a brushing.

### STATE OF THE PRIOR ART

To carry out this filling, the person skilled in the art uses techniques at his disposition, namely coating with a roller or screen-printing with the aid of scraper. These methods comprise pushing the product to be transferred before a roller or inclined scraper in order to generate a surge pressure in the product in preparation for forcing it to fill the zones in hollows. There are two types of problems with these devices of the prior art:
the first resides in the fact that in certain zones situated in hollows and closed on the other face, the air remains trapped and inhibits the product from completely filling them. To obviate this problem with the devices of the prior art, one must make multiple passages of the scraper or roller in order to obtain a filling without however really obtaining satisfaction because the product is not overthick at the point of the zones in hollows and always contains some air. Obviously, these multiple passages generate cycle times incompatible with mass production.
the second is tied to the fact that the product is redrawn by the filling element, which has a tendency to scoop the deposits in particular if they are of large dimension or if the product has a high viscosity. This problem is particularly striking when one uses a transfer roller.

Devices directed to filling blocked holes have been proposed in the past. Patent application PCT/FR00.03494 of the same applicant is an example. This technique comprises moving two slits on the surface of the substrate to be filled. The first slit is coupled to a vacuum generator while the second contains the filling product. The first slit is at the same time distant from the exterior and from the second slit by a distance greater than the largest opening on the substrate, the distance being measured parallel to the direction of displacement. In this case, the device is necessarily in impermeable contact with the substrate. Otherwise the filling of the blocked hole cannot be completely achieved. This technique is only applicable to blocked cavities of which the perimeter on the filling surface represents a closed zone. Furthermore, achievement of the vacuum is extremely difficult to obtain and to maintain on substrates of large dimension with possible surface irregularities.

There are screen-printing devices permitting the filling of through-holes in substrates with paste products and through a screen-printing mask. Thus, U.S. Pat. No. 6,533,162 describes this type of device in which a rotating roller in translation on the mask is employed in order to confer a surge pressure of the brazing cream at the front of the roller according to the movement of the device with respect to the substrate in order to fill the hole by driving out the air via the lower face of the substrate. A major disadvantage of this type of devices resides in the fact that the product transferred by the roller is redrawn at the back of the roller. In the case described in this patent, due to the presence of the printing block, the small dimension of the holes, and the rheology of the brazing cream, the redrawing of cream at the rear of the roller is limited and does not harm the quality of the filling. By contrast, this technique is not applicable to filling with a more or less pasty liquid product of zones in hollows closed on the other face possibly extending long lengths, that is to say several millimeters even several centimeters or decimeters and possibly presenting an aspect ratio, defined by the depth of the zone relative to the surface divided by the smallest aperture dimension, less than one. In fact, in this case, the filling product is redrawn on the one hand by the rear part of the roller which, as one can see, is exposed to the ambient air and on the other hand by the inclined scraper. Furthermore, this invention is not applicable to zones in hollows that are closed, because there is no mention of any means for extracting the gas present in the zones in hollows.

It is to be noted that in this patent the roller and the scraper, situated at the back, act successively and independently. In a first time, the roller will permit application of a pressure on the product situated on the forward part according to the movement of the device with respect to the substrate maintained fixed. Then in a second time, the inclined scraper will apply a second pressure on the product situated on the forward part according to the movement of the device with respect to the substrate maintained fixed, which has the effect of maintaining bubbles in the trenches and scooping the deposits.

U.S. Pat. No. 3,921,521 describes an ink screen-printing device on tissue substrates such as carpets. In this patent, a rotating cylinder is mentioned that permits generation of a hydrostatic surge pressure in a lower zone of the device, aided by a hydrodynamic effect. The goal in this patent is to create a surge pressure in the transfer zone in order to force the ink through the screen and to penetrate the tissue substrate by driving out the air through the base and the sides. Thus, this invention is applicable to porous substrates, but is not on the other hand applicable to filling of zones in hollows that are closed. In fact, no device for evacuating the air, present in zones in hollows, is provided. The use of this device for filling zones in closed hollows could lead to compressing the air in the zone in hollows at the time of the passage when the device faces the zone but may permit in no case a total filling, free of air bubbles.

In a general manner, it appears that the hydrodynamic effect is a known means for forcing the passage through a screen-printing mask in preparation for transferring a product but that this means by itself is not sufficient to eliminate the need to remove air bubbles and to deposit overthickness, which is precisely the goal of the invention.

### DESCRIPTION OF THE INVENTION

The present invention aims to fill without air bubbles and in over thickness, strictly at the point of zones in hollows directly on the printed circuit without screen or silk screen printing block by a more or less viscous liquid or paste product, of the inter-track or of the zones situated in hollows with respect to the surface of the substrate and more particularly of the zones closed on the opposing face and of which the length can be very long and/or having an aspect ratio defined by the depth of the zone relative to the surface of the substrate divided by the smallest aperture dimension, less than or equal to one, as for example zones situated between copper tracks.

According to the invention, the process of direct filling without air bubbles and in over thickness of inter-tracks or of zones situated in hollows with respect to this surface of a substrate or of a printed circuit by a viscous product is remarkable in that it comprises:
displacing the filling product at the point of the zones to be filled by means for displacing in order to evacuate in the form of bubbles, the gas present in the zones located in hollows and to substitute it by filling product,
and adjusting the thickness of the product at the surface of the substrate.

Beforehand at the step of displacing the product in the areas of the zones to be filled, the method of the invention proposes also to make the zone to be filled impermeable from all entry of exterior gas to the zone, by spreading the product at the surface of the substrate in order to isolate the zones to be filled from the exterior gas and make the product available. Thus, the impermeability is assured by maintaining the zone to be filled covered with product from the beginning of the filling up to the scraping of the excess or the adjustment of the thickness of the product at the surface of the substrate so that the filling product is displaced in the areas of the zone to be filled avoiding all later contact with exterior gas to the zone to be filled. At no time, from the spreading of the filling product up to the adjustment of the thickness, which can go up to the scraping of the total excess, should the zone to be filled be in contact with gas coming from the exterior of the zone to be filled.

In accordance with the fundamental actions that govern the principle of substitution of the air by filling product, the method, object of the present invention can be therefore decomposed into three steps in its implementation.

The first step comprises spreading the filling product on the surface of a substrate in a fashion to on the one hand isolate the gas present in the zones to be filled from the exterior and, on the other hand, to make the product sufficiently available in preparation for carrying out the filling and possibly the adjustment of the thickness of the product on the surface of the substrate.

The second step comprises displacing the filling product at the point of the zones to be filled in the substrate, permitting in this manner to create a forced circulation of product at the point of the zone to be filled in order to extract the gas in the form of bubbles. As the extraction of the gas proceeds, the corresponding volume is replaced by the filling product previously spread. The displacing of the filling product results in drawing the gas present in the areas in hollows in the form of bubbles and to thus permit its replacement by the product.

The third step comprises removing the surplus or to adjust the desired thickness at the surface of the substrate, this thickness possibly being null.

According to another characteristic of the invention, the displacing of the product at the point of the zone to be filled is obtained by a hydrodynamic effect, and preferably, by the hydrodynamic effect of a roller in rotation of which the axis is perpendicular to the movement of the substrate with respect to the device and parallel to the substrate and so that the tangential movement of the roller at the point of the zone to be filled is opposed to the direction of relative displacement of the substrate with respect to the device. In this manner, the adherence of the viscous product on the roller generates, by a hydrodynamic effect, a displacement of the filling product. The displacement increases as the distance with respect to the roller diminishes. At the surface of the roller, the speed of the product is equal to the tangential speed of the roller. Then it diminishes as one moves away from the roller. This reduction depends on the rheology of the filling product. In all cases, the roller will be arranged at a sufficiently small distance from the substrate so that hydrodynamic effect will be noticeable, for example such that the speed of the product is greater than or equal to fifty percent of the tangential speed of the roller at the point of the zone to be filled. Preferably, one will avoid contact between the roller and the substrate in order to, on the one hand, eliminate all risk of mechanical friction and, on the other hand, to avoid disturbing the hydrodynamic effect.

According to the invention, the filling of zones in hollows which, closed on the opposing face of the substrate, can also be of large length, is preferably assured with the aid of a more or less viscous product.

According to another characteristic of the present invention, the method of filling comprises associating a means of displacing the substrate in translation to the action of a filling head pushing on the substrate and containing the filling product, the aforementioned head permitting generation of a positive pressure differential between the downstream and upstream of the means of displacing of the product with the aid of the concerted action of the means for displacing of the filling product and of a scraping element forming in this manner a confined down zone of surge pressure totally occupied by the filling product and that the means of displacing of the product, constituted preferably by a roller contained in a filling head, causes a circulation of the filling product at the point of the zone to be filled in the direction opposed to the displacement of the substrate with respect to the filling head forming in this manner an upstream zone of reduced pressure in order to evacuate the gas present in the zones to be filled and to replace it by filling product as the displacement on the substrate progresses.

The direction of rotation of the roller, such that its tangential movement at the point of the zone to be filled is opposed to the direction of displacement of the substrate, will permit, on the one hand, to accumulate the filling product by way of the hydrodynamic effect, towards the scraping element in order to create a confined zone of surge pressure between the roller and the scraping element situated downstream from the roller and, on the other hand, to create a circulation of filling product at the point of the zones to be filled from the zone of surge pressure toward the zone of reduced pressure situated upstream from the roller.

The surge pressure created in the confined zone downstream under the concerted action of the displacing element and of the scraping element allows compensating for the effect of re-drawing and of scooping of the product by the scraping element, the redrawing being called the trail effect. Also, another advantageous characteristic of the invention comprises adjusting or selecting the speed of rotation and/or the diameter of the roller for displacing of the filling product in a fashion to adjust the differential pressure of the confined downstream zone of surge pressure with respect to the upstream zone of reduced pressure, allowing control of the spillover of product under the scraping element at the point of the zones to be filled and to compensate for the trail effect, of the aforementioned scraping element in order to be able to cause a deposition over thickness strictly opposing the zones in hollows.

According to another characteristic of the invention, in order to avoid that the bubbles extracted by the roller forming the displacing element are redrawn in the zone to be filled in hollows, it can be prudent to place a scraper at the surface of the roller situated in the filling head and ideally, tangentially on the upper part of the roller. Thus, when the roller rotates, the bubbles drawn by the movement of the product are blocked by this scraper and do not then have another alternative except to re ascend to the surface of the filling product as a result of the difference of density of the gas with respect to the product. In fact, the scraper has the purpose of interrupting the hydrodynamic effect, to locally eliminate the displacement of the product. It is notable that the gas is naturally evacuated as a result of the difference of pressure existing between the downstream and the upstream of the displacing element according to the direction of displacement of the substrate.

According to another characteristic of the method according to the invention, the displacing of the product can be adjusted. To this end, if the displacing device of the filling product is constituted by a roller in rotation, the speed of rotation of this roller is adjustable in a manner independent of the speed of translation of the substrate with respect to the device. The speed of rotation is adjusted according to of the speed of the substrate with respect to the device, of the rheology of the product and of the form of the areas in hollows to be filled. As indicated previously, the hydrodynamic effect can be more or less amplified by varying the diameter and/or the speed of rotation of the roller. In fact, the hydrodynamic effect is a function of the tangential speed of the roller. Thus, an increase of the diameter of the roller with a constant rotation speed generates an increase in the hydrodynamic effect. In the same manner, an increase of the speed of rotation with a constant roller diameter will engender also an increase of the hydrodynamic effect. The pair of parameters speed of rotation and roller diameter is selected according to the rheology of the filling product. In fact, by way of example, certain filling products do not support an excessive shearing caused by a too large speed of rotation. In this case, one will choose a roller of larger diameter with a reduced speed of rotation. By way of example, a roller diameter of 10 mm with a speed of rotation of 100 revolutions per minute gives excellent filling results with the filling products available on the market today. The speed of displacement of the printed circuit or of the substrate with respect to the filling device can be also varied according to of the hydrodynamic effect and of the shape of the zones to be filled. Very conclusive tests have been realized with a running speed of 30 mm/s. Finally, the distance between the roller and the surface of the substrate is adjusted according to essentially of the rhealogy of the product and of the depth of the areas to be filled. Here again, very positive results were obtained with a distance of 0.5 mm for tracks of 400 microns of thickness of filling products available today. Obviously all the values evoked above are given by way of example having occasioned very good results but it is possible to vary them in large proportions without departing from the present invention.

The invention also concerns a device allowing implementation of the filling method of the present invention. According to the invention, this device of the type without mask or screen printing screen for zones situated in hollows with respect to the surface of a substrate and closed on the other face of the substrate and possibly having a long length, with a liquid filling product more or less viscous in translation relatively to the surface of the substrate, is remarkable in that it associates in order according to the direction of relative displacement of the filling device with respect to the substrate:
a spreading element for the filling product at the surface of the substrate,
a displacing element for the filling product at the point of the zone to be filled, preferably constituted by a roller in rotation,
an element for adjusting the thickness or scraping the excess of the filling product,

in a manner such that the above mentioned filling product remains constantly in contact with the zone to be filled from the beginning of the filling up to the scraping of the excess.

In designing it in a symmetric fashion with respect to the displacing element of the filling product, this device can function in the two directions and be implemented on a silk screening machine. Thus, the displacement of the filling product can be reversed according to of the direction of advancement of the device with respect to the substrate.

Other characteristics and advantages will appear more clearly in view of the attached figures and their following description. The figures represent non-limiting examples of realization of the invention.

FIG. 1 represents in section a filling device according to the invention.

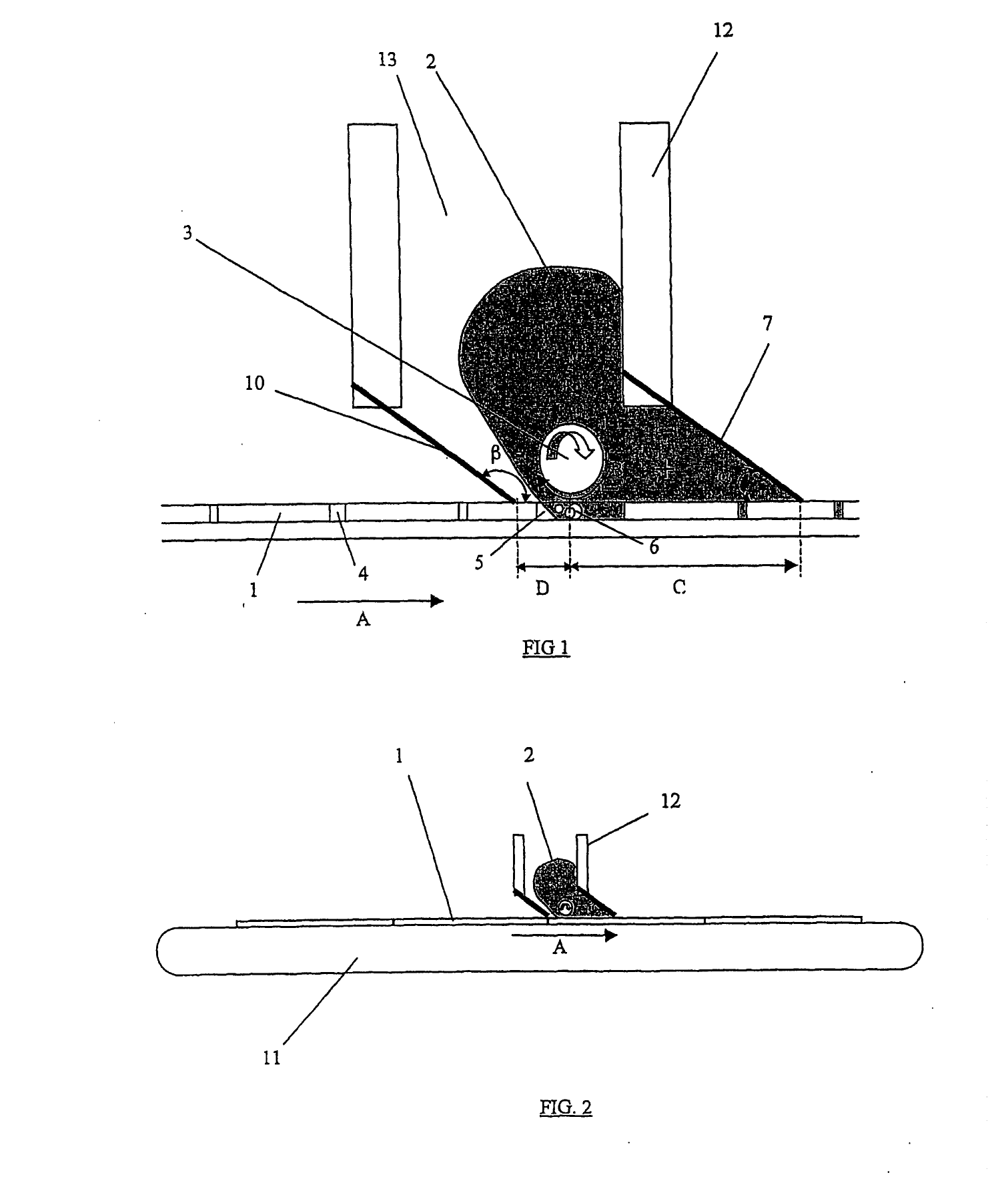

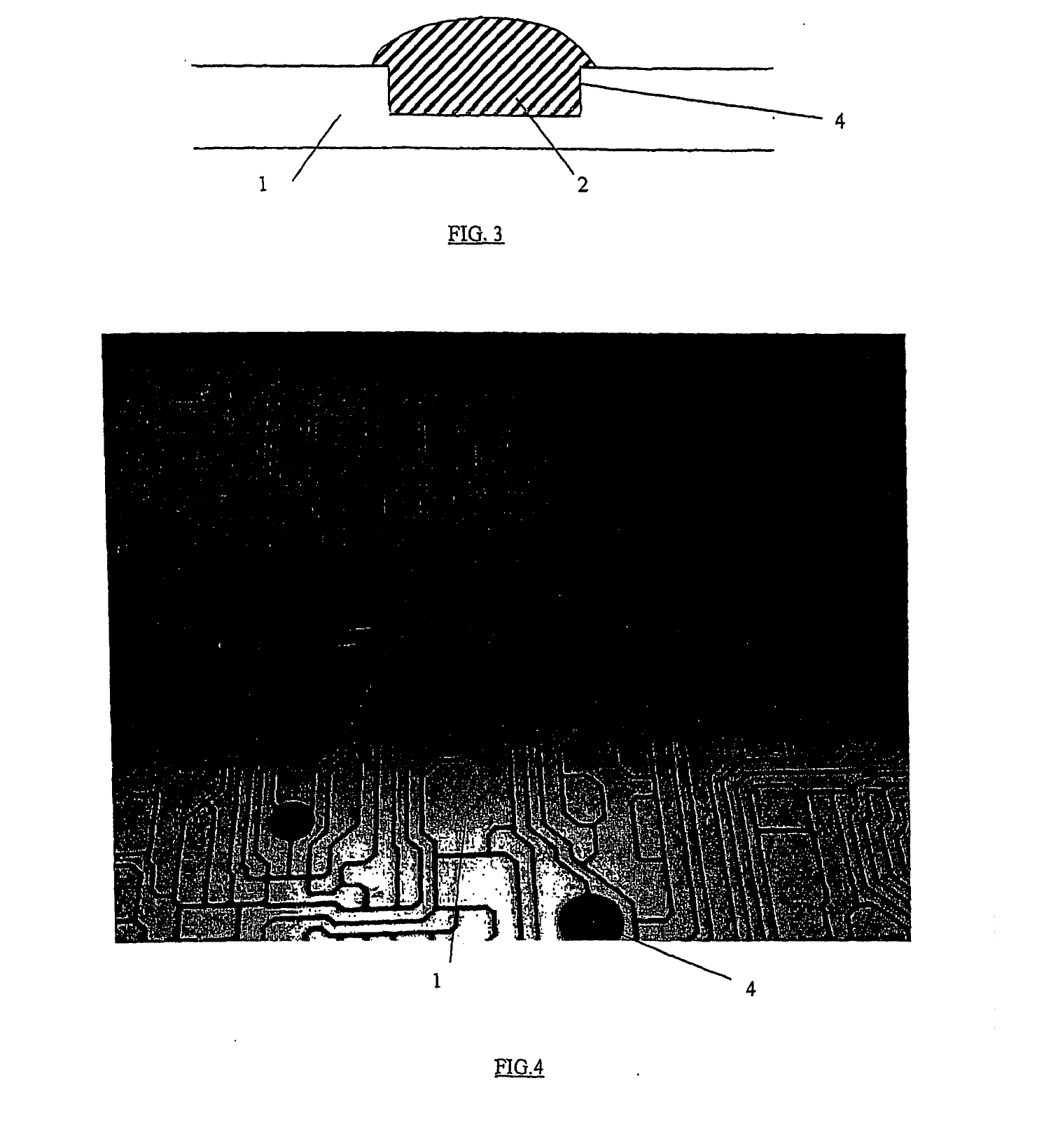

FIG. 2 represents in schematic fashion a means of translation associated with the filling device of FIG. 1.

FIG. 3 represents in section a filling of substrate carried out according to the present invention.

FIG. 4 shows in top view a photograph of a substrate to be filled.

FIG. 5 shows an enlarged detail of a substrate to be filled.

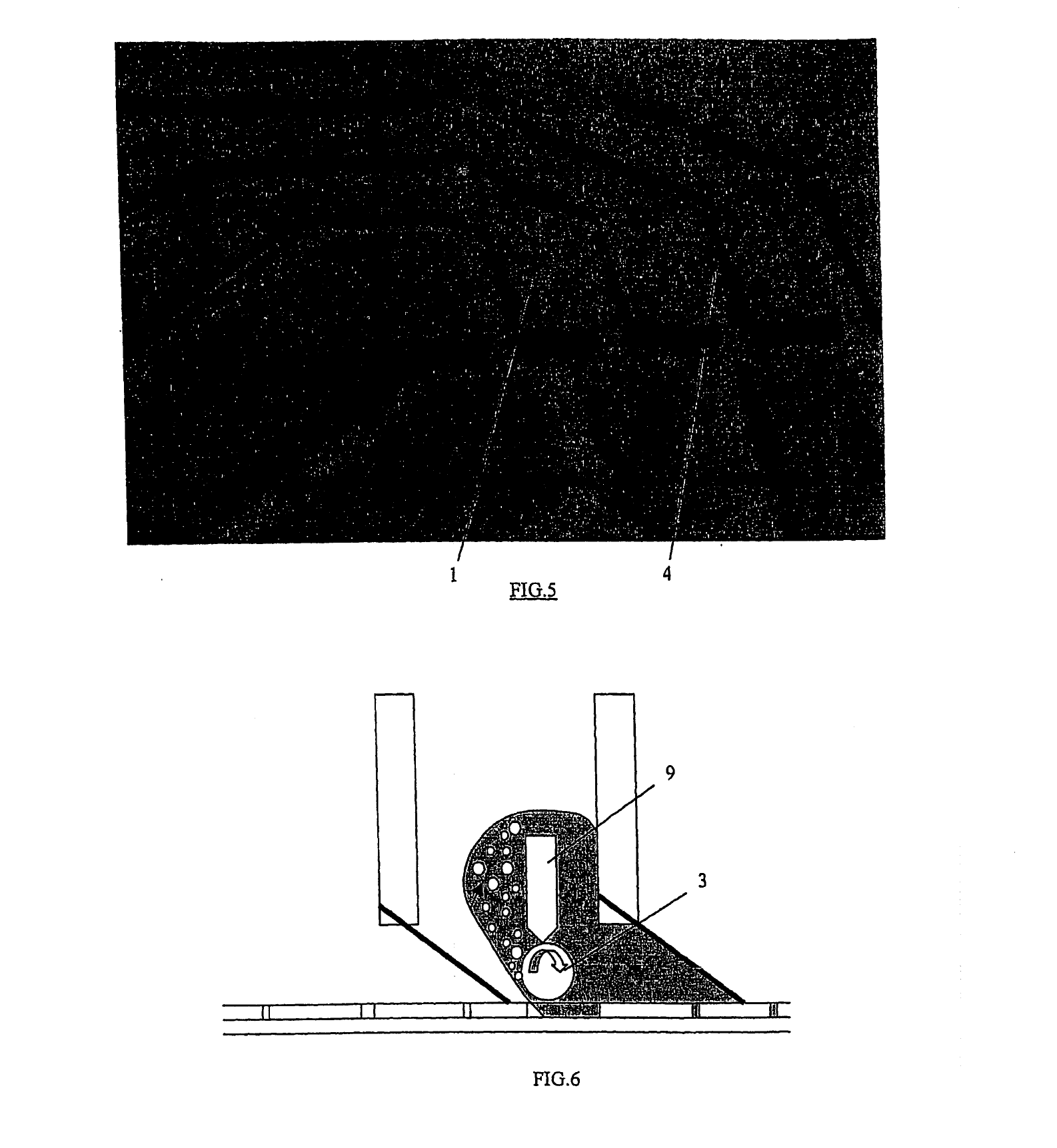

FIG. 6 shows a filling head equipped with a scraper of the displacing element.

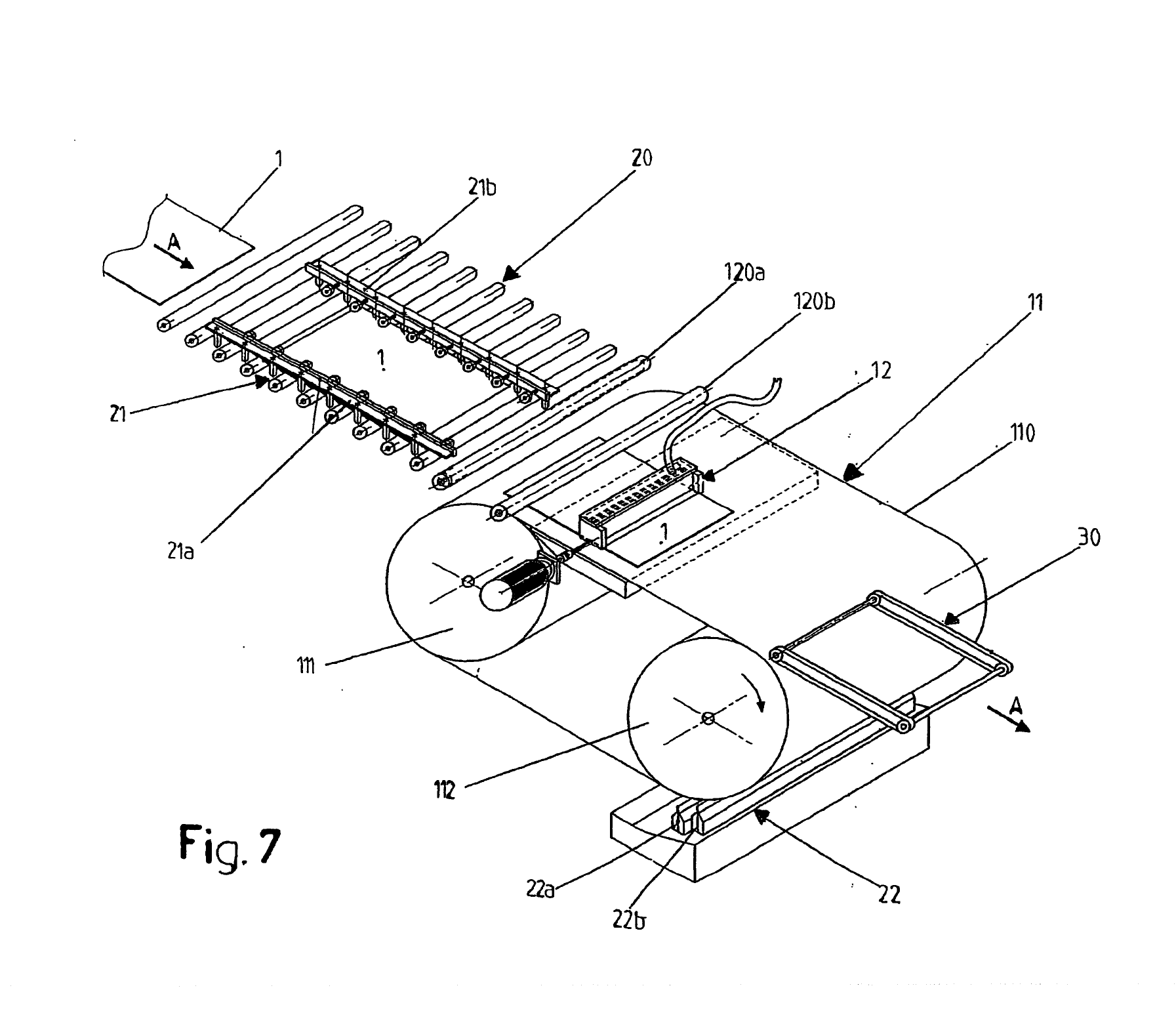

FIGS. 7, 8, 9 and 10 are perspective views illustrating the different phases of a mode of realization of an apparatus associated with the filling device of FIG. 1.

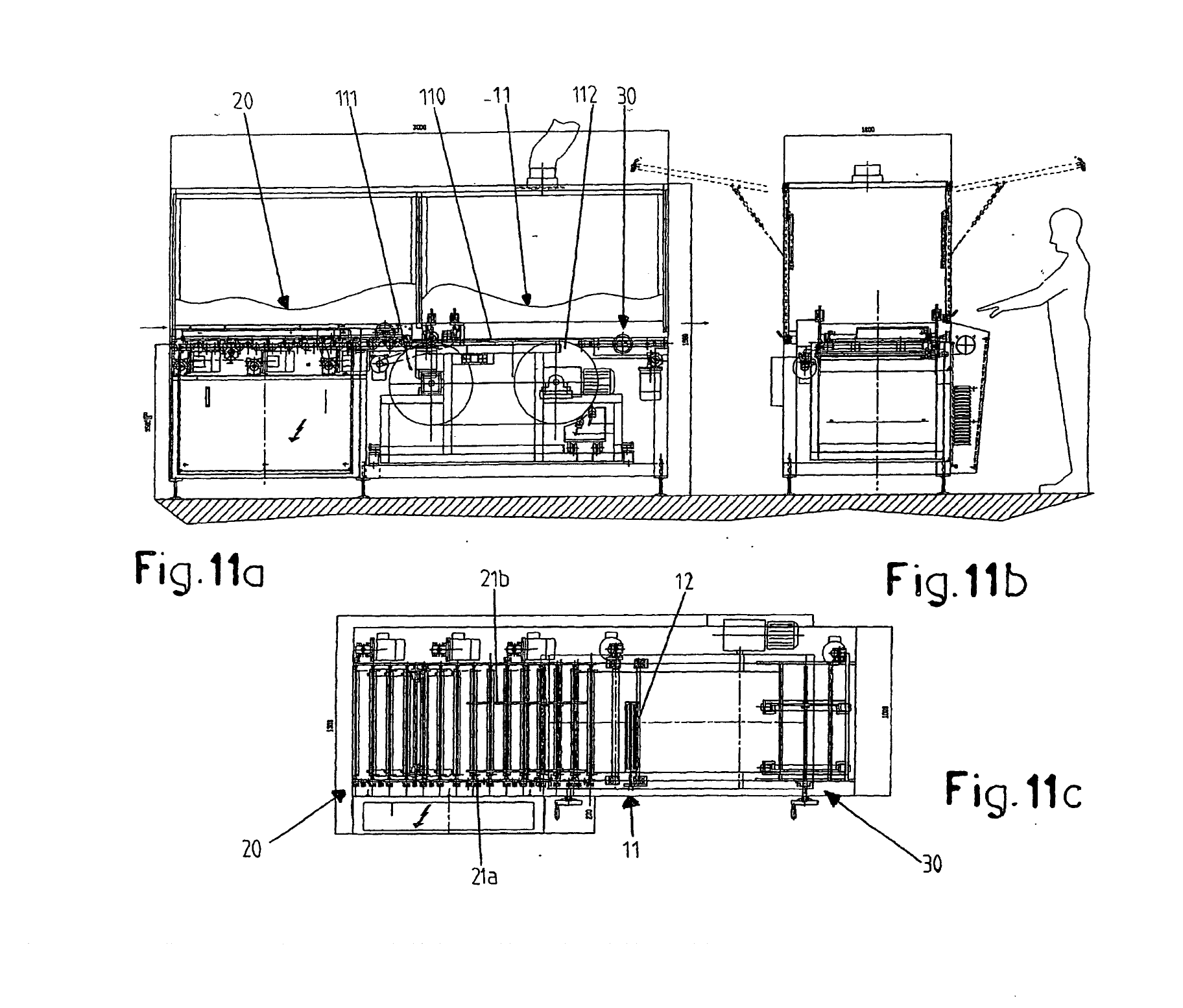

FIGS. 11a, 11b and 11c are views of the front, side, and top respectively of a complete realization mode of the apparatus of FIG. 7.

FIGS. 1 and 2 represent schematically and in section:
a filling head 12
and a means for displacement in translation 11 of a substrate 1, constituted here by a printed circuit, permitting a continuous running (arrow A) of it underneath the above-mentioned filling head 12.

Although the relative movement in translation of the filling head 12 with respect to the substrate 1 can be obtained by the displacement of the head 12 while maintaining the substrate 1 fixed, it is the alternative of maintaining the head 12 fixed and the substrate 1 mobile that has been adopted because it is easier to implement.

The filling head 12, realized in conformance to the principal arrangements of the present invention, includes:
a chamber 13 containing the filling product 2, the aforementioned chamber 13 being delimited downstream by a scraper 7 inclined from an angle α less than or equal to 90° and upstream by a scraper 10 inclined in the same direction with an angle β equal to or greater than 90°
and a roller 3 for displacing of the product 2 placed between the scrapers 7 and 10 and turning in the direction such that the tangential movement of the roller 3 at the point of the zones located in hollows to be filled 4 is opposed to the movement of translation A of the substrate 1 with respect to the filling head 12.

The rotation R of the roller 3 causes a displacement of the product 2 at the point of areas to be filled 4 as they pass under the roller 3, the latter turning in the direction B that is opposed to the direction of displacement A of the substrate 1 with respect to the filling head 12. The concerted action of the roller 3 and of the scraping element 7 generates as a result a downstream confined zone C of surge pressure in the product 2 situated between these two latter elements. In fact, the roller 3 generates a hydrodynamic effect and pushes the product 2 against the element 7, which is a wall inclined from an angle α less than 90° measured between the substrate 1 and the wall of the scraping element 7. It is particularly prudent to effect the scraping with the aid of an inclined wall 7 of which the angle of inclination can be adapted as a function of the rheology of the product 2 and of the speed of advancement A of the substrate 1 with respect to the filling head 12. Thus, the more the angle α will be small, the more the surge pressure in the confined zone C between the roller 3 and the scraping element will be high. The angle α of the downstream scraping element 7 of surplus of the product 2 is also adapted in order to limit the effect of redrawing or of trailing of product at the rear of the aforementioned scraping element 7.

As a result of this when the air 5 present in the areas in hollows 4 is evacuated by displacement or in the form of bubbles 6 and is replaced by product 2. If the air is evacuated in the form of bubbles 6, these are driven out from the product 2 due to the differential of pressure present in the confined downstream zone C and the upstream zone D of the roller 3. The roller of the upstream element 10 permits to contain the product 2 in the closed volume 13 and is inclined in the same direction as the wall of the downstream element 7 and forms an angle β greater than 90° with the substrate 1. Preferably, the filling head 12 will be closed allowing for the possibility of causing a certain level of vacuum in the part of the head 12 in a manner such that the resulting vacuum pressure promotes the evacuation of the extracted air from the zones to be filled 4. Also, there is the possibility to equip the filling head 12:
with a system of rapid fixation for switching from one head 12 to another,
with a sealing element at its lower part in order to avoid that the product 2 contained in the head 12 flows during a stoppage of production or during a change of head,
with a length adjuster so that it is adapted to the width of the substrate 1 in order to rapidly reconfigure the device of the invention according to the width of the printed circuit 1 to be treated,
etc . . .

It is also imperative that the filling product 2 be present in sufficient quantity to occupy all the confined space between the roller 3 and the scraping element 7. This condition is necessary to assure that the pressurization of the product 2. It is therefore envisionable to provide a device to maintain a minimum volume of product 2 in the filling head 12. Thus it is recommended to fill the filling head 12 with a minimum volume of product so that the roller 3 forming the displacing element of the product 2 is always entirely covered in the resting state.

In order to accentuate the displacement of the filling product 2, it can be prudent to modify the state of the surface of the roller 3, for example by striating it with ridges parallel to the axis of the roller or to provide the roller 3 with supple or rigid fins always parallel to the axis of the roller.

The drawing of FIG. 2, schematically represents a mode of realization of a conveyor 11 assuring the displacement of the substrates to be filled that run under the filling head 12, in the direction A. It is obvious that the conveyor 11 represented here formed from a conveyor belt could be replaced by a drive cylinder or any other device permitting the advancement A of circuit 1 under the filling head 12.

FIG. 3 is a sectional view of a substrate 1 of which the area and hollows 4 has been filled by product 2 according to the method of the present invention. As one can see it, the filling of the zone 4 is such that the product 2 is slightly over thick with respect to the substrate 1. This is particularly advantageous because one is thus certain of a complete filling and without plowing of the zones 4. This is made possible due to the confined zone of surge pressure caused under the concerted action of the displacing element 3 and the downstream scraping element 7. In fact, the surge pressure C is going to create a light running under the downstream scraping element 7 in the zone to be filled 4. This running is going to compensate for the trailing effect of the scraper and cause an over thickness strictly over the areas located in hollows 4.

On the photograph of the FIG. 4 showing a substrate 1 to be filled, one can see that the zones in hollows 4 are formed by inter-track zones that can extend over several centimeters. The goal of the invention is to fill the zones 4 with dielectric product in a complete manner and without bubbles. The difficulty of filling is due to the fact that the zones 4 are closed on the opposed face and as a result the air remains trapped in certain zones. For filling these zones, it is not sufficient to increase the pressure on the product, for this has only for effect to compress the air trapped in the zones located in hollows 4 during the passage of the filling head 12. For effectuating this filling, the present invention proposes thus to generate a flow of product 2 at the point of the zones to be filled 4 in order to draw away the air 5 present in the zones located in hollows 4 by displacement or in the form of bubbles 6, and to replace it as the process progresses by the filling product 2.

On the photograph of FIG. 5 showing a detail of the substrate 1 to be filled, one can perceive the depth of the zones to be filled 4, which here is approximately 400 microns. The conductive tracks are made of copper.

FIG. 6 represents schematically in section a filling head equipped with a scraper 9 arranged tangentially on the upper part of the roller 3 in order to interrupt hydrodynamic effect in order to locally eliminate the displacement of product 2 and cause the evacuation of air bubbles 6 by blockage on the wall of the scraper 9 and thus promoting the evacuation towards the surface.

In the case where the substrates 1 are constituted by printed circuits having thick layers of copper, the over thickness of product 2 will be easily removed during an intervening brushing after the polymerization of the product 2.

The filling method of the invention can function in an autonomous manner, for example with a rotation R of the roller with hydrodynamic effect 3 generated by an electric speed change drive unit, and with a movement of translation A of the substrate 1 with respect to the filling head 12 assured either manually or by an automatic driving device such as a conveyor, an assembly line, or a drive roller.

The drawing of FIG. 7 has the object of illustrating a mode of realization of an example of an apparatus associated with the filling head 12 for assuring the filling of areas located in hollows 4 of substrates 1.

As one can see it, this apparatus is composed of:
of the conveyor 11, which assures the translation A of the substrates 1 below the filling head 12,
of a feeding conveyor 20 situated upstream from the conveyor 11 in the direction of advancement A for transporting the substrates to be filled 1 towards the conveyor 11 below the filling head 12,
and of an evacuation conveyor 30 situated downstream from the conveyor 11 for recuperating the substrates 1 that have just been filled by the filling head 12.

According to the invention, the conveyor 11 is more precisely constituted by an endless belt 110 preferably realized in stainless steel and which, engaged driven around two cylinders 111 and 112, at least one of which is driving, is associated at the entrance to pressing cylinders 120a and 120b arranged above the belt 110 in order to maintain in pressure and to drive on the belt 110 below the filling head 12, the substrates 1 that have just exited the admission conveyor 20.

The feeding conveyor 20 of the rolling type includes a centering device 21 formed from two guiding rails 21a and 21b boarded on the interior by rolling rollers and which, mounted adjustable in width, permit to appropriately position the substrates 1 before their admission under the filling head 12 on the conveyor 11. As the conveyor 11 will be inevitably polluted by the product 2, arranged under the belt 110 is a continuous cleaning device 22 of the endless belt 110 constituted by one or several blades forming scrapers (two 22a and 22b being represented) pushed onto the external surface of the belt 110 under the conveyor 11. This cleaning device can also be replaced by a solvent applicator.

The evacuation conveyor 30 of the belt type permits guiding of the substrates 1 that have just been filled by the head 12 towards another treatment unit.

The functioning of the apparatus to fill circuits 1 of product 2 contained in the filling head 12 such as that just described above is simple and according in reference to FIGS. 7, 8, 9, and 10.

In a first time illustrated by the drawing of FIG. 7, the circuit 1 is positioned below the filling head 12 while another circuit 1 is guided between the two rails 21a and 21b of the centering device 21 of the admission conveyor 20.

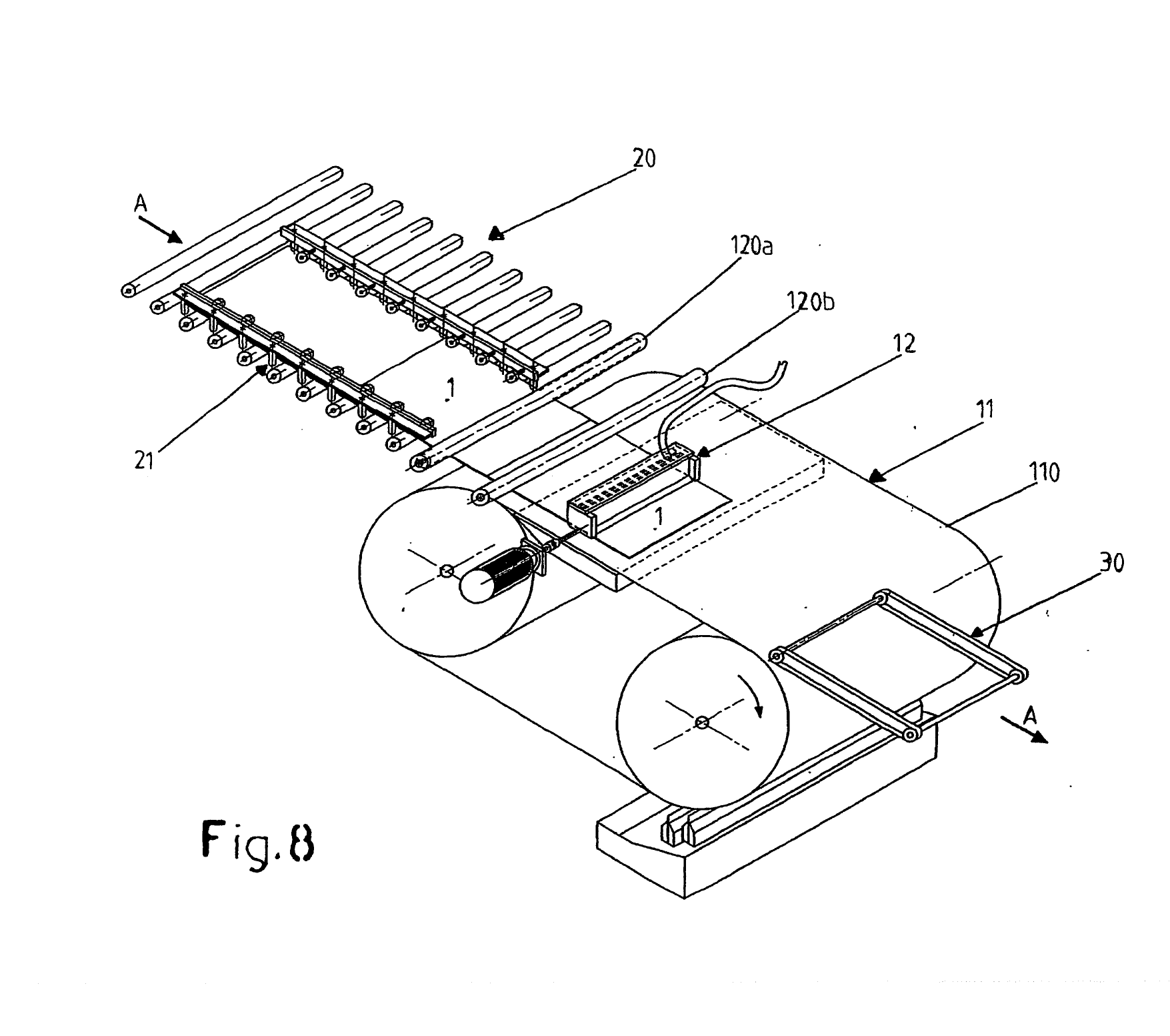

In a second time illustrated by the drawing of FIG. 8, the circuit 1 that has just been centered on the conveyor 20 is driven by the pressure rollers 120a and 120b of the conveyor 11 to come into contact with the circuit 1 positioned under the filling head 12 and which runs in the direction of the arrow A in order to fill its areas located in hollows 4 by the filling head 12 according to the method of the invention.

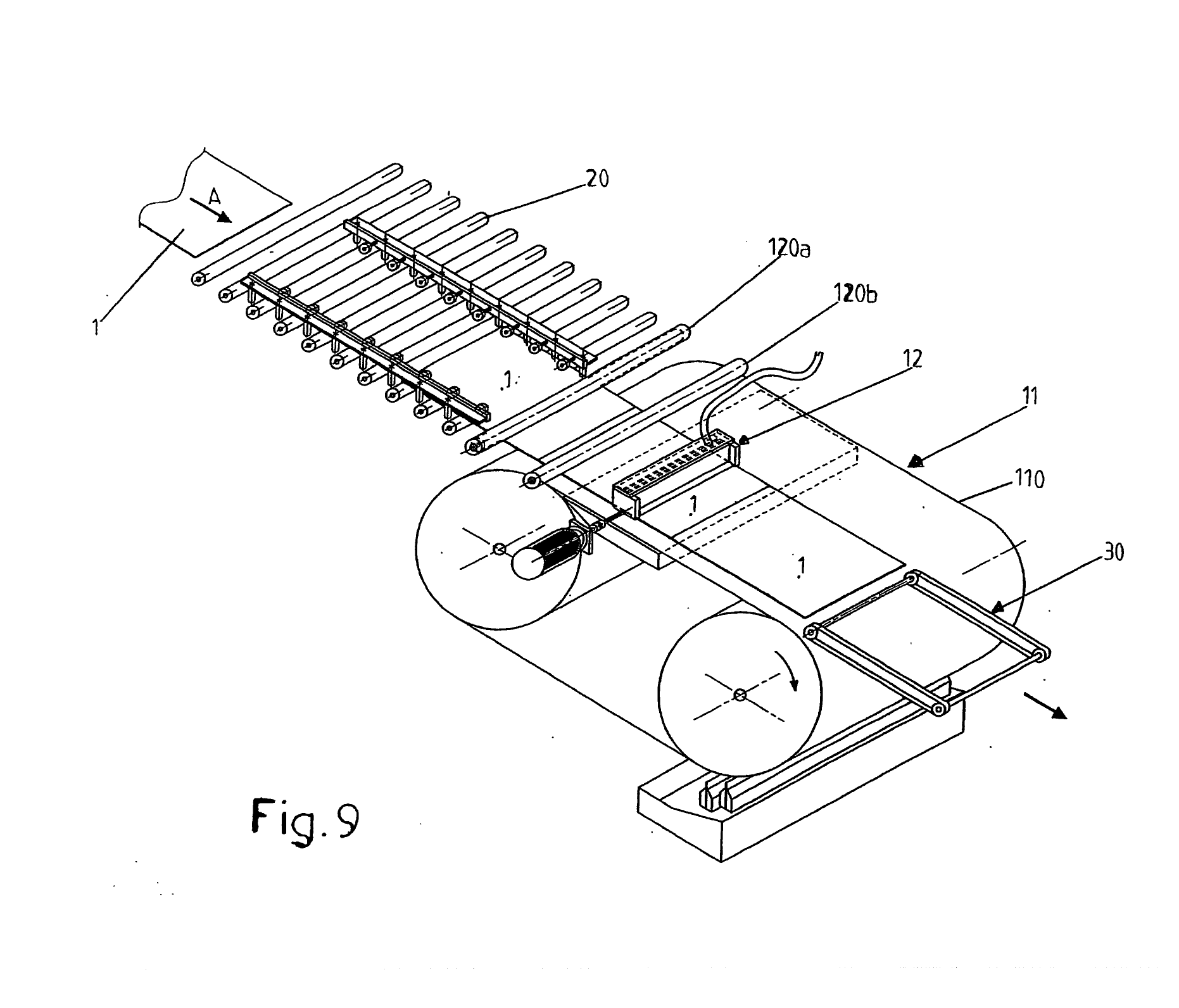

In a third time illustrated by the drawing of FIG. 9, the circuit 1 that was below the filling head 12 exits completely from the latter pushed by the preceding ones and via the endless belt 110, with product 2 applied by the head 12.

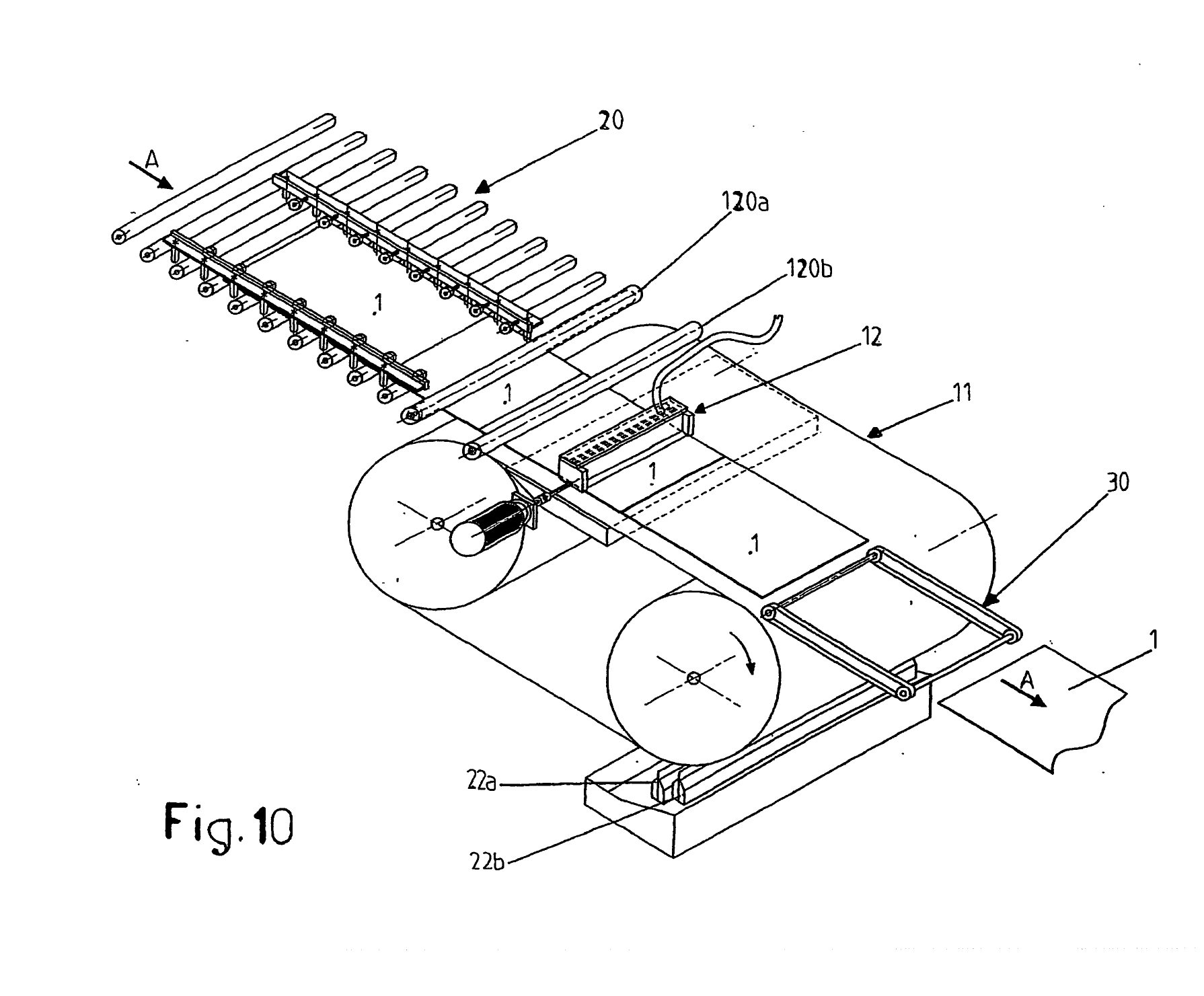

In a fourth time illustrated by the drawing of FIG. 10, the circuit 1 is transferred from the conveyor 11 to the conveyor having rollers 30 in order to provide transportation to another treatment unit or storage unit. This filling product 2 remaining on the belt 110 of the conveyor 11 is then removed and cleaned by the blades 22a and 22b of the device 22.

Thus, in this manner the device according to the invention permits running the circuits 1 under the filling head 12 in a continuous manner. In fact, due to the concerted action of the conveyor 20 and the pressing rollers 120a and 120b, the circuits 1 are in contact with each other during the passage under the head 12. This contact permits minimizing the pollution of the roller 110 by product 2.

The drawings of FIGS. 11a, 11b, and 11c show in views of the front, side, and top respectively a complete realization mode of such an apparatus showing the logical structure of the support mount and the drive members necessary to functioning:
of the conveyor 11 with its endless belt 110 engaged around the two cylinders 111 and 112 to assure the translation A of the substrates 1 below the filling head 12,
of the feeding conveyor with rollers 20 having the two guide rails 21a and 21b of its centering device 21 and which, situated upstream of the conveyor 11 in the direction of advancement A, guides the substrates to be filled 1 to the conveyor 11 below the filling head 12,
and of the evacuation conveyor 30 of the type having rolling rollers and which, situated downstream from the conveyor 11, for recuperating the substrates 1 that have just been filled by the filling head 12.

One will note that the feeding conveyors upstream 20 and downstream 30 are manually adjustable in position with respect to the central conveyor 11.

1-31. (canceled)

32. A method of filling and overlaying intertracks or zones in hollows with respect to a surface of a substrate or of a printed circuit, the hollows being closed at an opposing surface of the substrate, the method comprising:
displacing a viscous filling product, at the zones to be filled, using the hydrodynamic effect of a roller in rotation of which the axis is perpendicular to a movement of the substrate with respect to the roller, and parallel to the substrate and generating a pressure differential between the downstream and upstream of the roller with the aid of the concerted action of the roller and of a scraping element in order to evacuate, in the form of bubbles, the gas present in the zones in hollows and to substitute it by filling product; and
using the scraping element to adjust the thickness of the product at the surface of the substrate.

33. The method of filling according to claim 32 wherein it comprises successively:
making the zone to be filled impermeable to entry of gas exterior to the zone, by spreading the product at the surface of the substrate in order to isolate the zones to be filled from the exterior gas and to make the product available;
displacing the product at the zones to be filled in order to evacuate, in the form of bubbles, the gas present in the zones to be filled under the filling product;
substituting the gas evacuated in the form of bubbles, by the filling product; and
adjusting the thickness of the product at the surface of the substrate.

34. The method of filling according to claim 32 wherein the displacing of the product at the area to be filled is obtained by a hydrodynamic effect.

35. The method of filling according to claim 32 wherein it comprises blocking the gas bubbles extracted by the displacing means of the filling product, with the scrapping means so that they are not re-drawn in the zones to be filled.

36. The method of filling according to claim 32 wherein the zones to be filled have lengths in the range of several millimeters to several decimeters, the depth of a zone relative to the surface divided by the smallest aperture dimension being less than one.

37. The method of filling according to claim 32 wherein the speed of movement of the filling product is adjustable.

38. The method of filling according to claim 32 wherein the displacing of the filling product at the zone to be filled is obtained by a hydrodynamic effect of a roller in rotation of which the axis is perpendicular to the movement of the substrate with respect to the device and parallel to the substrate and according to the direction such that the tangential movement of the roller at the zone to be filled is opposed to the direction of displacement of the substrate.

39. The method of filling according to claim 32 wherein it associates a means for displacement in translation of the substrate to the action of a filling head resting on the substrate and containing the filling product, the head permitting the generation of a positive pressure differential between the downstream means for displacing of the product due to the concerted action of the means for displacing of the filling product and a scraping element forming in this manner a confined downstream zone of surge pressure totally occupied by the filling product and the means for displacing causes a circulation of the filling product at the zone to be filled in the direction opposed to the displacement of the substrate with respect to the filling head forming in this manner an upstream zone of reduced pressure in order to evacuate the gas present in the zones to be filled and to replace it by filling product as the substrate is displaced.

40. The method of filling according to claim 32 wherein the roller assuring the displacement of the filling product is contained in the above-mentioned filling head.

41. The method of filling according to claim 39 wherein the speed of rotation and/or the diameter of the abovementioned roller contained in the filling head are adjustable in order to adjust the pressure differential of the confined zone of surge pressure with respect to the zone of reduced pressure permitting control of the running of the product under the scrapping element at the zones to be filled and to compensate for the trailing effect of the scrapping element.

42. A filling device, configured to operate without mask or silk screen, for zones located in hollows with respect to a surface of a substrate and closed on an opposing surface of the substrate and extending from several millimeters to several decimeters, the depth of a zone relative to the surface divided by the smallest aperture dimension being less than one, the filling device configured to be in translation relative to the surface of the substrate and implementing the filling method according to claim 32 wherein it comprises, in the order according to the direction of relative displacement of the filling device with respect to the substrate:
a spreading element for the filling product at the surface of the substrate,
a displacing element for the filling product at the zone to be filled, the displacing element acting in accordance with a hydrodynamic effect of a roller in rotation having an axis perpendicular to the movement of the substrate with respect to the device and parallel to the substrate, and generating a pressure differential between the downstream and upstream of the roller, with the aid of the concerted action of the roller and of a scraping element in order to evacuate in the form of bubbles the gas present in the zones in hollows and to substitute it by filling product, and
an element for adjusting the thickness or scraping the excess of the filling product, in a manner such that the above mentioned filling product remains constantly in contact with the zone to be filled from the beginning of the filling up to the scraping of the excess.

43. The filling device according to claim 42 wherein the displacing element includes a roller in rotation.

44. The filling device according to claim 42 wherein the device is symmetric in order to be able to operate in the two directions and to be implemented on a silk screen machine.

45. The filling device according to claim 42 wherein the relative movement in translation of the filling product relative to the surface of the substrate is obtained by maintaining the filling device for the product fixed while the substrate is moving.

46. The filling device according to claim 42 further including a scraper for blocking the bubbles extracted by the abovementioned displacing element.

47. The filling device according to claim 42 further including a filling head comprising:
a) a chamber containing the filling product, the chamber being delimited downstream by a scraper inclined at an angle less than or equal to 90° and upstream by a scraper inclined in the same direction at an angle equal to or greater than 90°,
b) a roller placed between the scrapers for displacing of the product and turning in the direction such that the tangential movement of the roller at the zones to be filled is opposed to the movement in translation of the substrate with respect to the filling device, and
a means for displacement in translation of the substrate, permitting a continuous running of it under the above-mentioned filling head.

48. The filling device according to claim 32 wherein the above-mentioned means for displacing in translation of the substrate is a conveyor belt.

49. The filling device according to claim 47 wherein the filling head is equipped with a sealing element arranged in its lower part.

50. The filling device according to claim 47 wherein the above mentioned filling head is adjustable in length according to the width of the substrate to be treated.

51. The filling device according to claim 47 wherein the above mentioned filling head is adapted to the width of the substrate to be treated and that a system of rapid fixation permits switching from one filling head to another.

52. The filling device according to claim 47 wherein the above mentioned roller comprises fins parallel to the axis of the roller in order to accentuate the displacement of the filling product.

53. The filling device according to claim 47 wherein the above-mentioned scraper is tangentially placed on the upper part of the displacing element in a manner to cause the evacuation of the air bubbles.

54. The filling device according to claim 43 wherein the above-mentioned substrate is a printed circuit.

55. The filling device according to claim 43 wherein the above-mentioned filling head containing the filling product is closed.

56. The filling device according to claim 43 wherein the above mentioned filling head containing the filling product is closed with creation of a level of vacuum in its part situated above the filling product to promote the evacuation of the extracted air from the zones to be filled of the substrate.

57. An apparatus associated with a filling device according to claim 43, the apparatus comprising:
a conveyor that facilitates the translation of the substrates below the filling head;
a feeding conveyor situated upstream from the conveyor to transport the substrates to be filled to the conveyor below the filling head; and
an evacuation conveyor situated downstream from the conveyor for recuperating the substrates that have just been filled by the filling head.

58. The apparatus according to claim 57 wherein the conveyor includes an endless belt and that engaged around first and second cylinders, the first cylinder driving, and is associated at the entrance to pressing cylinders arranged above the belt in order to maintain under pressure and to drive the substrates that have just exited the admission conveyor onto the belt below the filling head.

59. The apparatus according to claim 57 wherein the feeding conveyor is the roller type and comprises a centering device formed from two guiding rails bordered on the interior by rolling rollers and that, mounted adjustable in width, permit to appropriately position the substrates before their admission under the filling head on the conveyor.

60. The apparatus according to claim 57 wherein it comprises a continuous cleaning device for the endless belt that, constituted by a blade arranged to push onto the external surface of the belt under the conveyor to form scrapers.

61. The apparatus according to claim 57 wherein the evacuation conveyor is of the belt type and permits transportation of the substrates that have just been filled by the head to another treatment unit.
